(19) United States
(12) Patent Application Publication
(10) Pub. No.: US 2019/0064507 A1
(43) Pub. Date: Feb. 28, 2019

(54) LIGHT-REFLECTING OBJECT AND METHOD FOR PROVIDING AN OBJECT OF THIS TYPE

(71) Applicant: PCH INNOVATIONS GMBH, Berlin (DE)

(72) Inventors: Markus KISON, Berlin (DE); Stefan LISKE, Berlin (DE)

(73) Assignee: PCH INNOVATIONS GMBH, Berlin (DE)

(21) Appl. No.: 16/080,000

(22) PCT Filed: Feb. 14, 2017
(86) PCT No.: PCT/EP2017/053250

§ 371 Date: Aug. 25, 2018

(30) Foreign Application Priority Data
May 3, 2016 (DE) 10 2016 108 234.1

(51) Int. Cl. G02B 26/08

(52) U.S. Cl. CPC G02B 26/0816

(57) ABSTRACT

The invention relates to a light-reflecting object having a multiplicity of individually aligned mirrors, which are suitable for reflecting incident light such that the reflected light forms a predefined pattern on a projection surface. Provision is made for the multiplicity of mirrors to be formed or arranged on a curved target surface of the object, wherein each of the mirrors on the curved target surface of the object is aligned such that it images light, which is incident from a specified direction, onto exactly one pixel of the projection surface, and wherein the pattern that is formed on the projection surface is formed by the multiplicity of the pixels which are thus produced. The invention furthermore relates to a method for providing such a light-reflecting object.

### REFERENCE TO RELATED APPLICATION

This application is a National Phase Patent Application of International Patent Application Number PCT/EP2017/053250, filed Feb. 14, 2017, which claims priority of German Patent Application No. 10 2016 108 234.1, filed on May 3, 2016, the entire contents of both of which are incorporated herein by reference.

### BACKGROUND

The invention relates to a light-reflecting object and to a method for providing such an object.

T. Weyrich et al: “Fabricating Microgeometry for Custom Surface Reflectance,” ACM Transactions on Graphics (Proc. SIGGRAPH) 28(3), August 2009, describe the provision of a predefined pattern on a projection surface by aligning a multiplicity of mirror surfaces in a planar two-dimensional array in a defined manner. The light reflected by the mirror surfaces forms the desired pattern.

The present invention is based on the object of providing a light-reflecting object and a method for producing it, which produce a desired predefined pattern by way of light reflection at a multiplicity of mirrors.

### SUMMARY

According to an aspect of the invention provision is made for a multiplicity of mirrors to be formed or arranged on a curved target surface of a three-dimensional object, wherein each of the mirrors on the curved target surface of the three-dimensional object is aligned such that it images light that is incident from a specified direction onto exactly one pixel of the projection surface. One pixel of the projection surface is here a region of the projection surface onto which light reflected by one mirror is incident. The pattern formed on the projection surface is formed by the multiplicity of the pixels which are produced in this way.

The solution is based on the idea of forming a multiplicity of reflective mirrors on a curved target surface. Desired patterns produced by light reflection can hereby be provided by objects of any desired shape, which results in a wider field of use. The arrangement of the reflective mirrors on a curved target surface is moreover associated with the advantage that it reduces the risk that a mirror is situated in the beam path of the light that is reflected by an adjacent mirror and in this way impedes the light reflection at the adjacent mirror.

The pattern produced represents an illumination pattern. It is predefined because it is uniquely prescribed by the alignment of the mirrors on the target surface and the direction of the incident light.

A predefined pattern within the meaning of the present invention has a contiguous shape that is produced on the projection surface by way of light reflection at the mirrors. Contiguous here means that each pixel of the pattern onto which the light that is reflected by a mirror is incident adjoins at least one further pixel of the pattern onto which light that is reflected by a mirror is incident. Thus, the pattern forms an illuminated surface or an illuminated line consisting of a plurality of pixels. If a pattern consists of an illuminated surface, the outermost pixels of the surface here form a boundary line of the pattern. The pixels forming a predefined pattern consequently form a contiguous collection of pixels on the projection surface. An individual pixel alone, on the other hand, does not represent a pattern within the meaning of this invention.

The fact that the pixels are contiguous, or at least two pixels adjoin one another, does not necessarily mean here that the pixels touch or even overlap. A certain distance between the pixels, which is preferably smaller than the smallest diameter of the pixels, may be present. Overall, however, the pixels form a line or a surface which represents a design.

The pattern can have a semantic or aesthetic meaning, for example represent an animal or an object, or have an aesthetically pleasing form. Provision may also be made for a plurality of patterns to be projected onto the projection surface in neighborhood with respect to one another.

The projection surface is generally a planar surface. However, in principle it may also be a curved surface.

The light-reflecting object in accordance with an implementation of the invention is arranged immovably, in particular non-rotatably, in space. It is typically situated on a base. Implementations of the invention may also provide for a pivotable arrangement of the three-dimensional object (e.g.

on a rotatable plate), wherein the pattern that is imaged on the projection surface moves if the light source that irradiates the three-dimensional object does not also move.

In accordance with an implementation of the invention, provision is made for the mirror is to be arranged and aligned such that, for at least one of the pixels, light that forms said pixel was reflected by exactly one of the mirrors. Such a pixel of the pattern that is formed on the projection surface is consequently formed by the light of exactly one mirror.

Alternatively, provision may be made for the mirror to be arranged and aligned such that, for at least one of the pixels, the light that forms said pixel was reflected by a plurality of the mirrors. In this variant, one pixel of the pattern that is formed on the projection surface is consequently formed by light from a plurality of mirrors. In other words, a plurality of the mirrors are aligned such that the light they reflect is incident on one and the same pixel or forms the same. The effect that is attained hereby is that the relevant pixel is brighter than other pixels which are formed by the light that is reflected at only one mirror. This can be independent of whether the target surface of the reflective object, on which the mirrors are arranged, has a curved or a planar design.

In accordance with an implementation of the invention, provision is made for such pixels of the projection surface to be assigned a plurality of mirrors that have a greater distance from the curved target surface. “Greater distance” here is understood to mean a distance that is greater than the average distance between the mirror and associated pixel of the pattern that is formed by reflection.

Pixels that have a greater distance from the curved target surface of the object are naturally less bright, because the light had to travel a greater distance since its reflection at a mirror and can have a lower illuminance due to divergence and scattering. In particular, a plurality of mirrors are assigned to pixels of the projection surface that make up the 20%, the 10% or the 5% of the pixels that have the greatest distance from the respectively assigned mirror.

The assignment of a plurality of pixels to one pixel, however, can have other reasons than a large distance from the target surface, for example in order to make specific structures within the pattern more noticeable.

A further implementation of the invention makes provision for the mirrors to be arranged and aligned such, and for the direction from which the light is incident on the mirrors to be specified such, that, for at least some of the mirrors (in particular for the majority of or all the mirrors), the angle of a light ray, which has been reflected at an observed mirror, with respect to a plane that is perpendicular to the plane of the projection surface is between 30° and 60°, in particular between 40° and 50°. For the case that the curved target surface of the three-dimensional object and the projection surface are perpendicular with respect to one another, said plane is the plane in which the target surface is located. For this case, the angle between the light ray, which has been reflected at an observed mirror, and the projection surface is also between 30° and 60°, in particular between 40 and 50°. In other words, the light ray after reflection at the observed mirror preferably travels at an angle of 45° or at an angle of approximately 45°, specifically an angle between 30° and 60°, with respect to the target surface and the projection surface. This prevents mirrors in the lower region of the target surface from projecting far away at a very flat angle and consequently distorting the image. At the same time, mirrors in the upper region of the target surface are prevented from projecting to just before the target surface and having to be strongly inclined as a consequence, as a result of which they can reflect only little incident light, which likewise results in a reduced quality.

By aligning the mirror such that the reflected light travels in the range between 30° and 60°, in particular at or near 45°, with respect to the target surface, distortions and darkening are largely avoided and pixels of the pattern of at least approximately the same brightness are provided. As already explained, this does not preclude specific pixels of the pattern from experiencing an increased brightness due to the light of a plurality of mirrors being directed at them. Even this embodiment variant can be provided independently of whether the target surface of the reflective object, on which the mirrors are arranged, has a curved or a planar design.

In accordance with a further exemplary embodiment of the present invention, provision is made for the mirrors to be arranged and aligned such that some of the mirrors which are adjacent to one another have an identical or similar alignment such that they form in the multiplicity of the mirrors letters or numbers or a specific design which is recognizable for an observer. The effect thus provided permits the integration of letters, numbers or designs in the reflective surface, which form, for example, a company logo or company slogan. The mirrors that contribute to the formation of letters, numbers or designs also serve, like all the other mirrors, to form pixels of the desired pattern. It may be necessary herefor not to align in an optimum fashion the mutually adjacent pixels, which form letters, numbers or a design, in the sense that, for example, the above-mentioned angular range of between 30° and 60° is not realized for these pixels. Even this embodiment variant can be provided independently of whether the target surface of the reflective object, on which the mirrors are arranged, has a curved or a planar design.

The individual mirrors can be embodied in a material block or in a plurality of material blocks consisting of an aluminum alloy or including the latter. The individual material blocks can here in principle have any desired shape, in particular the shape of a cube or a cuboid or of thin plates. It is also possible for the material blocks to have a reflective alloy other than an aluminum alloy. For the present invention, it is not the material forming the reflective surface that matters. In principle, any reflective materials can be used.

Provision may furthermore be made for the mirrors to be embodied in material blocks that are connected to one another at their rear side and thereby form a curved plate, wherein the curved plate forms the curved target surface of the three-dimensional object and is inserted in a cutout formed in the three-dimensional object. In accordance with this implementation, the mirrors are consequently prefabricated on a plate and pre-aligned before they are then secured to the three-dimensional object, for which purpose a cutout is formed in the latter or is already present, into which the prefabricated plate with the individual mirrors is inserted.

The individual mirrors in accordance with an implementation of the invention are designed to be planar mirrors. If the light source is known or predefined, it is hereby possible in a simple manner to calculate the alignment of the mirrors, if the mirror is intended to form a specific pixel in a defined projection surface. However, provision may alternatively be made in principle for individual mirrors or all mirrors to be curved. For example, individual mirrors or all mirrors can be concave mirrors for focusing the reflected light and forming pixels of greater illuminance.

The mirrors are provided for example by way of a highly precise milling process, wherein provision may be made for a mirror surface to be milled a plurality of times, in particular twice, in order to optimize the mirror quality.

In accordance with an implementation of the invention, provision is made for the mirrors to be arranged and aligned such that the reflected light forms the predefined pattern on the projection surface if the light that is incident from a specified direction is parallel light. Parallel light here means that the incident light rays substantially travel parallel with respect to one another, i.e. come from a light source which is located very far away. The light that is incident on the multiplicity of mirrors, which are arranged on the curved target surface, from a specified direction is thus parallel light. If the light rays are here not exactly parallel and/or if they do not come exactly from the specified direction, this does not mean that the predefined pattern would no longer be produced; in that case, it is merely distorted, with the degree of distortion depending on the degree of the deviation from the direction and parallelism.

Alternatively, provision may be made for the mirrors to be arranged and aligned such that the reflected light forms a predefined pattern on the projection surface if the light that is incident from a specified direction is coming from a point light source. The light that is incident on the multiplicity of mirrors, which are arranged on the curved target surface, from a specified direction is thus coming from a point light source. This variant can make sense for example if the object that is provided with the mirror surface is presented in a positionally fixed manner and an illuminating light source which is arranged at a defined location is facing it. Even in this case it is true that the predefined pattern is still produced, albeit at a lower quality, if the light is incident on the mirrors not exactly from the spatial point that is assumed to be the light source.

The invention also relates to a method for providing a light-reflecting surface which consists of a multiplicity of individually aligned mirrors and is suitable for reflecting incident light such that the reflected light forms a predefined pattern on a projection surface. The method comprises arranging or forming a multiplicity of mirrors on a curved target surface of a three-dimensional object, wherein each of the mirrors on the curved target surface of the three-dimensional object is aligned such that it images light, which is incident from a specified direction, onto exactly one pixel of the projection surface, and wherein the pattern that is formed on the projection surface is formed by the multiplicity of the pixels which are thus produced.

The individual mirrors can be arranged on the curved target surface, i.e. the mirrors are mounted for example by way of adhesive bonding to the target surface and thereby aligned in the desired manner. The individual mirrors, however, can also be formed on the curved target surface, i.e. the mirrors are formed on the three-dimensional object or on an object that is connected to the three-dimensional object. The latter variant has the advantage that not every individual mirror must be aligned separately.

In accordance with an implementation of the invention, each of the mirrors has a planar surface which is aligned such that the surface normal thereof forms the bisector of the angle formed by the incident light ray and the light ray that is reflected onto one of the pixels. Here, the planar surface for each mirror is separately produced by a milling process such that each mirror has the desired alignment. Provision may be made here for the mirrors to be formed by milling from a material block or by milling from a plurality of material blocks before the material block or the material blocks are arranged on the three-dimensional object or after the material block or the material blocks have been arranged on the three-dimensional object.

A further implementation of the invention makes provision for the mirrors to be arranged on the curved surface such that the light, which is reflected at an observed first mirror, cannot be blocked by a second mirror that is adjacent to the first mirror. Reducing the risk that the light, which is reflected by a mirror, is blocked by an adjacent mirror is an immediate consequence of the fact that the mirrors are arranged on a curved surface. By arranging mirrors on strongly curved regions of the target surface of the object, this risk can be further reduced.

An implementation of the invention makes provision for suitable data to be fed to a milling machine for milling the individual mirrors. To this end, provision may be made for 3D data of the curved surface of the three-dimensional object and data relating to the number, position and alignment of the mirrors to be combined in a file which provides milling data for a milling machine. In order to reduce the number of the parameters of such a file and consequently the quantity of the data to be processed, provision may be made here for the X- and Y-data of the curved surface and/or the X- and Y-data of the position of the mirrors to be coded in each case by the position in a list, such that the list now only needs to include the corresponding Z-data. The position within the sequence of data consequently codes the X-Y information.

### BRIEF DESCRIPTION OF THE DRAWINGS

The invention will be explained in more detail on the basis of exemplary embodiments with reference to the accompanying drawings in which:

FIG. 1 shows an arrangement having a light-reflecting object that has a multiplicity of mirrors which, upon illumination from a specified direction, form a pattern on a projection surface;

FIG. 2 shows the arrangement of FIG. 1 with illustration of the light reflection on one of the mirrors of the light-reflecting object;

FIG. 3 shows an enlarged illustration of the individual mirrors of the light-reflecting object, wherein the individual mirrors are aligned in different ways;

FIG. 4 schematically illustrates the process of milling the individual mirrors to produce a respectively planar mirror surface, which is aligned in a defined manner;

FIG. 5A schematically illustrates a light reflection at mirrors which are arranged on a curved target surface of a light-reflecting object;

FIG. 5B schematically illustrates a light reflection at mirrors which are arranged on a planar target surface of a light-reflecting object;

FIG. 6 shows a further illustration of an arrangement having a light-reflecting object, which forms a pattern on a projection surface upon illumination;

FIG. 7 shows a pattern which is formed in a projection surface by a light-reflecting object, wherein some of the pixels of the pattern are formed by light of a plurality of the mirrors of the light-reflecting object;

FIG. 8 shows a further exemplary embodiment of a light-reflecting object, which forms a pattern on a projection surface upon illumination, with the illustration of the assignment of mirrors and pixels produced by the mirrors, and with the integration of letters in the light-reflecting surface of the light-reflecting object; and

FIG. 9 shows a flowchart for producing a light-reflecting surface of a light-reflecting object.

### DETAILED DESCRIPTION

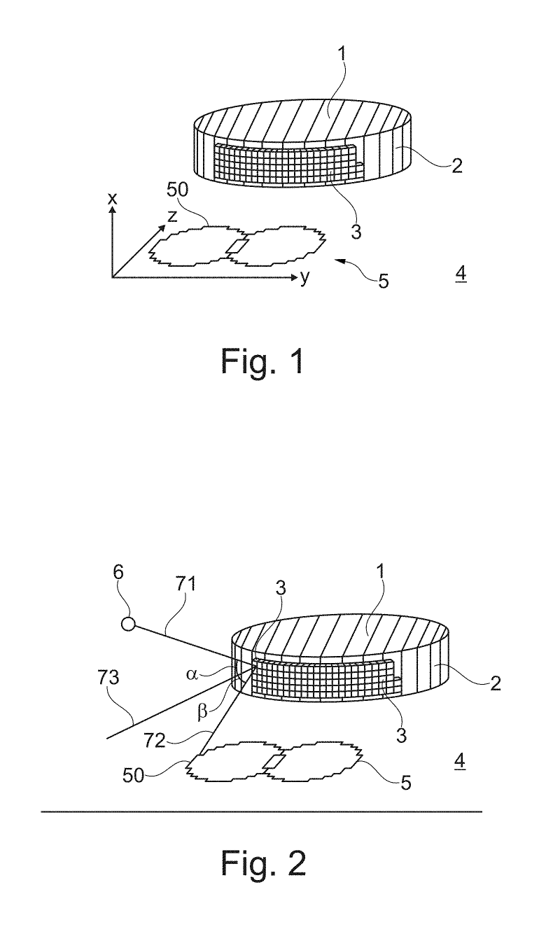

FIG. 1 shows a three-dimensional light-reflecting object 1, having a light-reflecting surface 2. Said surface is curved and will also be referred to below as the target surface 2. A multiplicity of mirrors 3 are arranged on the target surface 2. The point of the arrangement of the mirrors 3 on the target surface 2 is for the mirrors 3 to produce, upon illumination with light that is incident from a specified direction, a predefined pattern 5 on a projection surface 4.

The pattern 5 consists of a defined number of bright pixels 50. One pixel 50 here represents a region of the pattern on which light is incident that has been reflected by one of the mirrors 3. The multiplicity of mutually adjoining pixels 50, which are thus produced, form the pattern 5. The pattern 5 is therefore an illumination pattern.

The three-dimensional object 1 can be selected as desired and have a target surface 2 of any desired shape. The individual mirrors 3 are placed individually onto the target surface 2 in a CAD program and aligned therein. Their physical embodiment is realized using a milling process, as will be explained below.

It should be noted that the target surface 2 and the projection surface 4, into which the pattern 5 is projected, are at least approximately perpendicular to one another. However, since the target surface can in principle have any desired shape, the case may likewise be that an observed partial region of the target surface 2, which has an approximately planar embodiment, is located in a plane which is not perpendicular with respect to the projection surface 4. Reference is also made to the fact that the projection surface 4 does not have to be formed by the surface on which the object 1 is situated, but can alternatively also be provided by a different surface, for example by an adjoining wall region.

The alignment of the individual mirrors 3 will be explained below with reference to FIG. 2. Each mirror 3 is aligned such that it reflects (images) the light, which is incident from a specified direction, onto an assigned pixel 50 of the pattern 5. It can be seen in the exemplary embodiment of FIG. 2 that the light is emitted by a point light source 6, which has a predefined position in space and consequently with respect to object 1. The light source 6 emits light rays 71. A light ray 71 is reflected at a mirror 3 in accordance with the law of reflection, which specifies that the angle of incidence α equals the angle of reflection β. The reflected light ray is designated with 72. The angle bisector 73 between the incident ray 71 and the reflected ray 72 here is the perpendicular of the planar mirror surface of the mirror 3. In order that the light 71, which is reflected at a specific mirror 3, is incident on a specific pixel 50, the mirror surface, or the perpendicular 73 thereof, must thus be aligned such that the incident light 71 is reflected onto the desired pixel 50.

If the position of the light source 6 is known and the intention is to provide a desired reflection pattern 5, then the alignment of the individual mirrors 3 that is necessary herefor can be mathematically calculated relatively easily via the stated relationships. Once the mirrors are correspondingly aligned with the object 1, or the target surface 2 thereof, illumination of the mirrors by way of a light source 6, which is arranged at a predefined location, necessarily results in the desired pattern 5.

It should be pointed out that there does not have to be a necessary assumption that the light that is incident on the mirrors 3 is coming from a point-type light source 6 in the far field. Alternatively, there can be an assumption that the incident light is parallel light. During the calculation of the alignment of the mirrors 3, in the latter case the same direction from which the incident light is coming is to be taken into account for all mirrors 3.

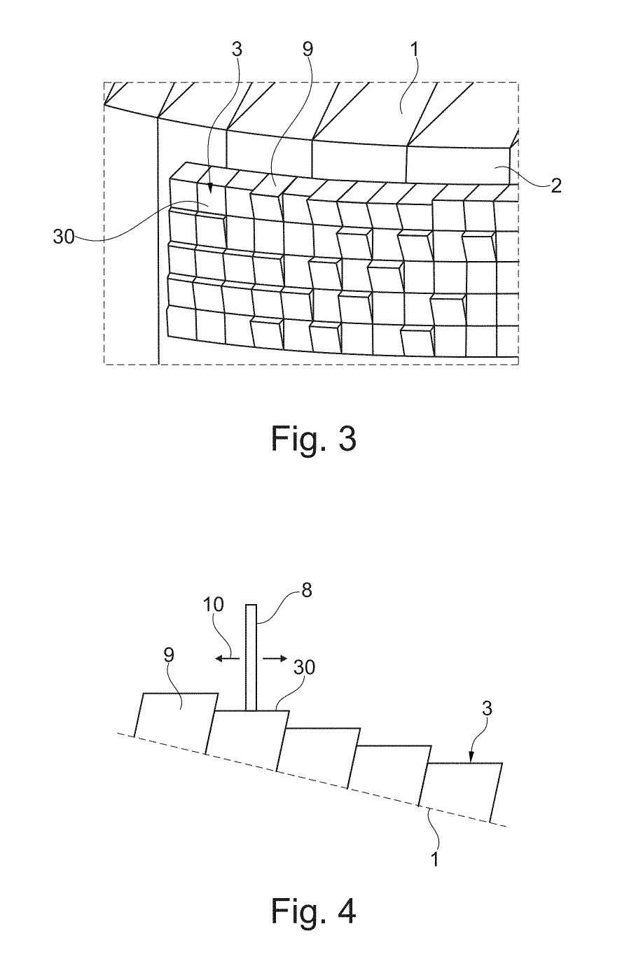

FIG. 3 shows, in an enlarged illustration, a multiplicity of mirrors 3, which are arranged on a target surface 2 of a three-dimensional object 1. Each of the mirrors 3 is here aligned, in accordance with FIG. 2, such that light that is incident on the mirror 3 from a predefined direction forms a defined pixel of an illumination pattern 5. The individual mirrors are arranged in rows and columns. Each mirror 3 has a planar mirror surface 30, which faces away from the object 1. The individual mirrors 3 are arranged directly adjacent to one another in rows and columns, such that they form, overall, one substantially continuous mirror surface.

At the same time, it should be pointed out that the arrangement of the mirrors 3 in rows and columns is not mandatory. For example, the mirrors 3 can alternatively be arranged in concentric rings. It should also be pointed out that the illustration of the individual mirrors 3 as miniature cubes in FIGS. 1-3 only serves as an example and for better elucidation. In principle, the material blocks 9 that form the mirrors 3 can have any desired shape. For example, the mirrors 3 are alternatively formed on flat, plate-type material blocks. The individual mirrors can also be formed on only one material block.

For the realization of reflective surfaces, the mirrors 3 are formed for example in material blocks 9 that consist of an aluminum alloy or include the same. For example, this is an aluminum alloy with copper as the main alloy element, for example of the type EN AW 7075 (AlZn5.5MgCu). However, instead of an aluminum alloy, it is also in principle possible for any other metal (for example gold) or any other metal alloy, which provides a reflective surface, to be used.

Reference is further made with respect to FIG. 3 to the fact that provision may be made for the individual material blocks 9 to be connected to one another at their rear sides, forming a curved plate in the process. Such a curved plate is then inserted into a correspondingly shaped cutout (not illustrated) in the object 1. The advantage of such an implementation is that the individual mirrors can be provided and aligned before the arrangement on the object 1, and alignment and milling correspondingly do not have to be performed at the object itself (although it may).

FIG. 4 shows a milling head 8 of a milling apparatus, which is milling the individual mirrors 3 using CAD software. The milling head 8 is here, for example, a constituent part of a 5-axis milling machine, wherein the workpiece, that is to say the object 1 or an object that is connected to the object 1, is rotatable about three axes for each individual mirror surface 30 of the material block 9. Each individual mirror surface 30 is milled in planar fashion by the milling head 8 in a horizontal plane 10.

In principle, it is possible here for the individual mirrors 3 or mirror surfaces 30 to be produced alone by the milling process, without the individual mirrors being assigned in each case individual material blocks 9. In this implementation, the individual mirrors 3 are consequently milled from one overall material block. The provision of individual material blocks 9 on which the individual mirrors 3 are formed has, however, the advantage that, with suitable alignment of the material blocks 9, the material blocks can be pre-aligned, such that the milling operation becomes shorter and simpler. If the individual mirror surfaces 30 are produced by the milling operation alone, then milling requires a thicker material removal than when only the surfaces 30 of pre-aligned material blocks 9 are machined further. Both variants can be realized.

As already explained, the milling process can moreover be performed selectively either before the individual material blocks are arranged on the object 1 or after they have been arranged on the object 1. In both cases, provision may be made for the individual material blocks, as already explained, to be connected to one another at their rear sides in accordance with an embodiment variant.

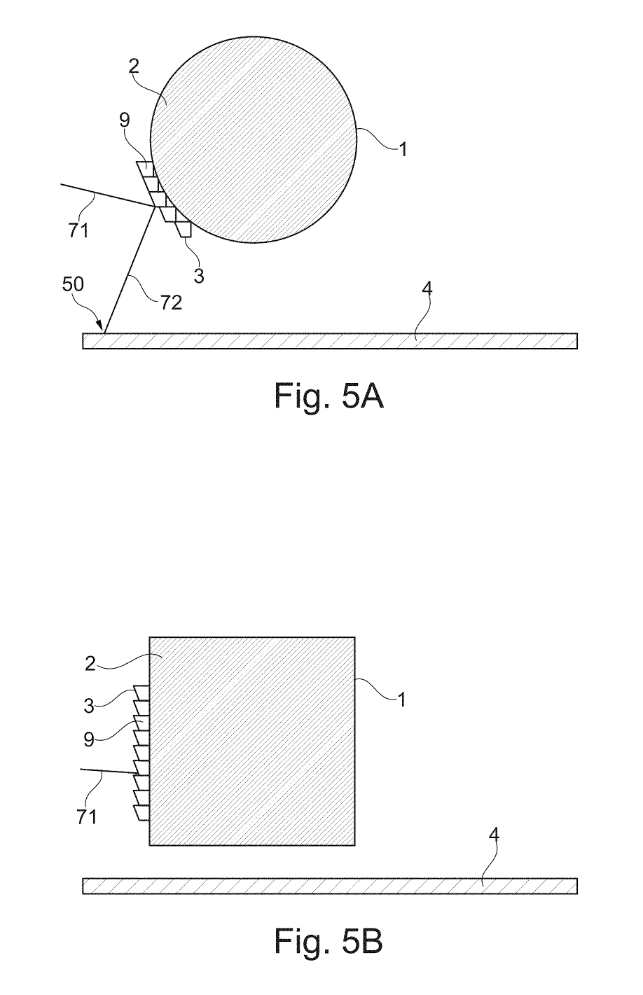

The target surface 2 of the object 1 in accordance with the exemplary embodiment of FIGS. 1 to 4 has a curved embodiment, i.e. is not planar. This is associated with the advantage of reducing the problem that a mirror blocks light that was reflected at an adjacent mirror. This is explained on the basis of FIGS. 5A and 5B. In accordance with FIG. 5A, a multiplicity of mirrors are arranged on a curved target surface 2 of an object 1. An incoming light ray 71 is reflected at a mirror 3 and, after reflection, forms a reflected light ray 72, which forms a light pixel 50 on a projection surface 4. Due to the curvature of the surface 2, the individual mirror surfaces have a relatively strong offset with respect to one another, such that the risk of a reflected light ray being blocked by an adjoining mirror or the material block 9 or the material region in which the mirror 3 is formed is reduced.

The situation in accordance with FIG. 5B is different in the case of an object 1 having a planar target surface 2. The risk here is that in particular light rays 71, which are incident on a mirror 3 in the peripheral region thereof, are blocked by the material block 9 on which the adjacent mirror is formed. Formation of a pixel by this light ray is then no longer possible, or a corresponding pixel has a lower luminous intensity.

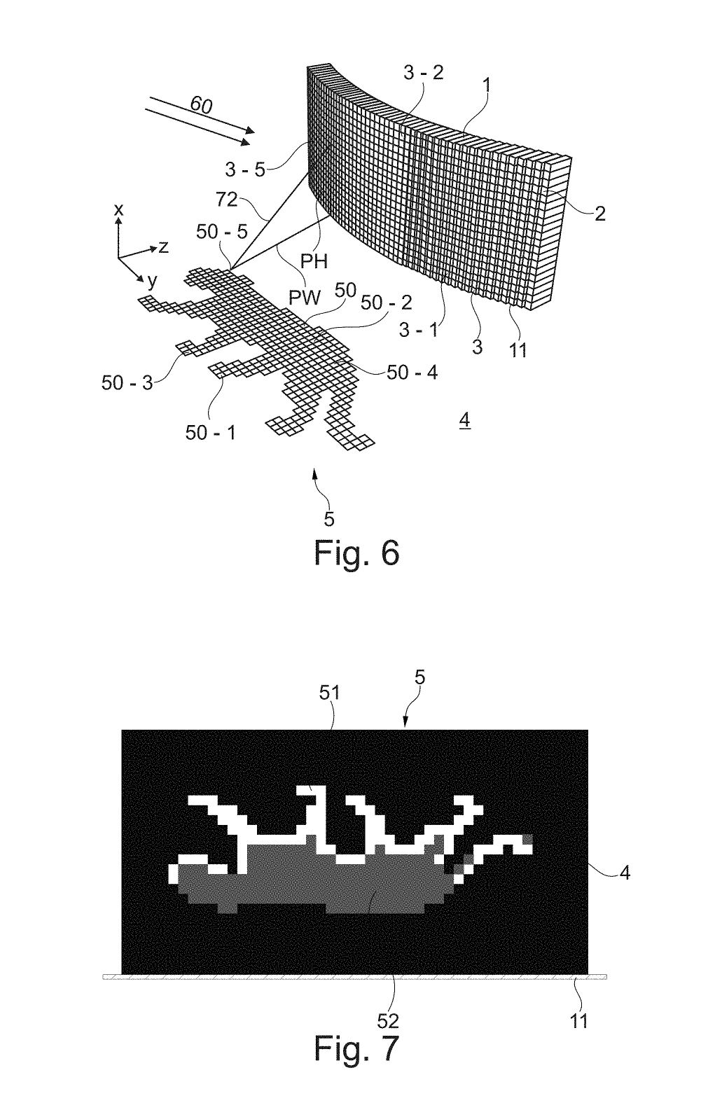

FIG. 6 shows a further arrangement, in which a light-reflecting object 1, which is irradiated with light 60 from a specific direction, provides a predefined pattern 5 on a projection surface 4. The light-reflecting object 1 has once more a curved target surface 2, comprising a multiplicity of mirrors 3. The incident light 60 is parallel light, unlike the exemplary embodiment of FIG. 2. Provision could, however, alternatively be made for the light to originate from a point light source.

The light that is reflected at a mirror 3 forms on the projection surface 4 a pixel (light pixel) 50, with the totality of the pixels forming the desired pattern 5. The projection surface 4 is, for example, the surface of the table or the like, on which the object 1 is situated. The target surface 2 of the object 1 and the projection surface 4 are at least approximately perpendicular to one another, although this is not necessarily the case.

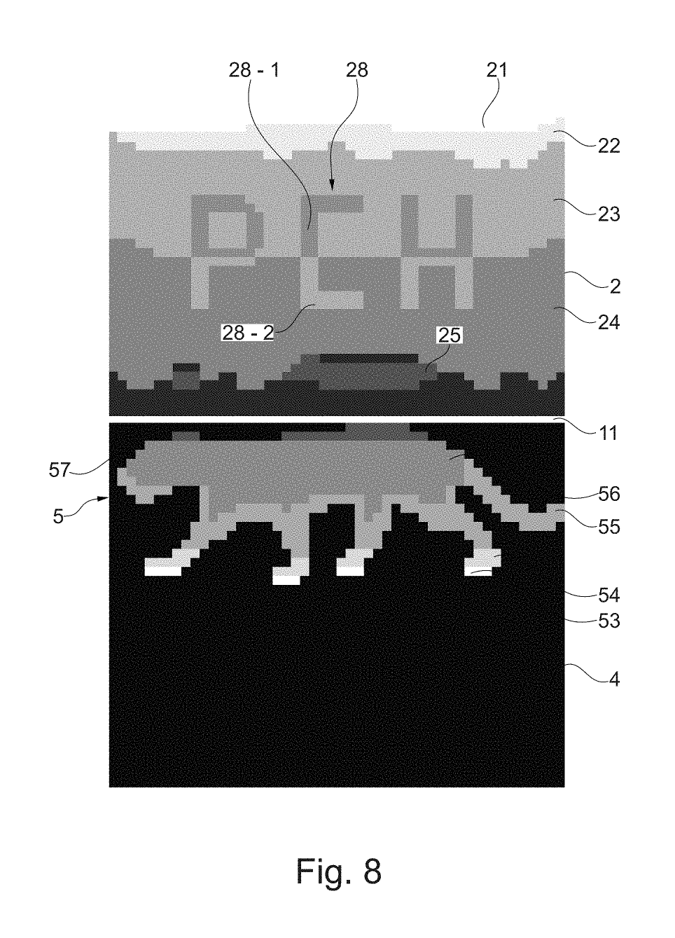

It is required for arranging and aligning the mirrors 3 on the target surface 2 to assign a pixel 50 to each mirror. Consequently, an assignment between mirrors 3 on the one hand and pixels 50 on the other must be performed. The following statements including the explanations relating to FIGS. 7 and 8 are aimed at performing an assignment that is as favorable as possible in the sense that the pattern 5 to be imaged is present at a high quality.

A simple assignment between mirrors and pixels can be performed in a manner such that the mirrors which are arranged in a grid are numbered by rows, wherein, once the end of a row is reached, the numbering is continued at the start of the row below. For example, if mirrors are arranged in 5 rows and 10 columns, each row has 10 elements, and the mirrors can be numbered from 1-50. Correspondingly, the pixels 50 of the pattern 5 to be formed can also be numbered, wherein counting is performed row by row. If it is assumed that there are exactly as many mirrors 3 as there are pixels 50 (exceptions in this respect will be explained with reference to FIG. 7), then an assignment between mirrors and pixels can be performed simply by assigning the N-th pixel to the N-th mirror. The mirrors must here be aligned such that the light 60, which is incident from a specific direction, is reflected by each mirror onto the pixel that is assigned to the mirror, in accordance with the procedure explained with respect to FIG. 2.

Such a simple assignment, however, can be associated with disadvantages. Two such disadvantages will be explained below with reference to FIG. 6.

First, reflected light that has traveled a relatively long distance between mirror and pixel forms a pixel of lower luminosity than light that has traveled a relatively short distance between mirror and pixel. For example, the pixels 50-1 and 50-3, which have a relatively large distance from the edge 11, formed by the object 1 with respect to the projection surface 4, exhibit a lower luminosity than the pixels 50-2 and 50-4, which are located relatively close to the edge 11. The reason is that the illuminance of the light decreases as the distance increases due to reflection (for example in dusty air) and due to divergence. One solution to this problem is described with respect to FIG. 7.

It is also assumed that the mirror 3-1 and the pixel 50-1 are assigned to one another, i.e. that the light 60 that is incident on the mirror 3-1 is reflected onto the pixel 50-1. The mirror 3-1 is formed relatively far toward the bottom of the target surface 2, near the edge 11, and must therefore project at a flat angle with respect to the projection surface 4, and in addition, the assigned pixel 50-1 is formed relatively far away from the edge 11, which is formed by the object 1 with respect to the projection surface 4. Since the light ray is projected far away and at a flat angle by the mirror 3-1, there is a higher likelihood that the pixel 50-1 that is formed by the mirror 3-1 is distorted.

The assumption is further that the mirror 3-2 and the pixel 50-2 are assigned to one another. The mirror 3-2 is formed relatively far toward the top on the target surface 2 and projects onto a pixel 50-2, which is arranged adjacent to the edge 11. The mirror 3-2 must therefore be inclined to a very great extent, in particular if the pattern 5 is formed very close to the edge 11. One solution to this problem is described with respect to FIG. 8.

FIG. 6 also illustrates the terms projection width and projection height. Considered here are a mirror 3-5 and a pixel 50-5, which are assigned to one another. The light that is reflected by the mirror 3-5 onto the pixel 50-5 is designated with 72. The vertical distance between the mirror 3-5 and the projection surface 4 is referred to as the projection height PH. The horizontal distance, i.e. the distance in the projection surface 4 between the pixel 50-5 and the projection of the mirror 3-5 onto the projection surface 4, is referred to as the projection width PW.

FIG. 7 shows a pattern 5, which is formed in a projection surface 4 and comprises a multiplicity of pixels. The associated object 1 having a light-reflecting surface 2 is not illustrated in FIG. 7. The object extends substantially perpendicular to the drawing plane. Only the edge 11 is shown, which is formed by the object 1 with respect to the projection surface 4.

Provision is made in FIG. 7 for the pattern 5 to have pixels 51, onto which the light from a plurality of mirrors of the target surface 2 is reflected. These pixels are consequently formed by light which has been reflected at two or more mirrors. Accordingly, these pixels 51 are brighter than pixels 52, onto which the light from only one mirror is reflected. By assigning at least two mirrors to one pixel, the brightness of said pixel 51 is increased. As illustrated in FIG. 7, provision may here be made for such brighter pixels 51 to be formed in regions of the pattern 5 which have a larger distance from the object 1, or the edge 11. It is hereby possible to compensate for the effect that pixels which are formed at a greater distance from the object 1, or from the edge 11, have a lower brightness.

The assignment of a plurality of mirrors to one pixel, however, can be done for different reasons, for example to make specific regions of the pattern appear brighter.

Provision is made in FIG. 8 for specific mirror regions of the target surface 2 to be assigned to specific regions of the pattern 5 in a specific manner. The assignment is performed here such that, at least for the plurality of the mirrors, the angle of a light ray that is reflected at a mirror under consideration and the target surface 2 is between 30° and 60°, in particular between 40° and 50°, in particular close to 45°. In other words, for as many regions of the mirror surface as possible, the reflected light is to be reflected at an angle close to 45° with respect to the target surface 2 of the light-reflecting object 1, such that there is no need for individual mirrors to project light far away at a very flat angle, nor for mirrors with great inclination to project to only just before the target surface.

It is necessary herefor that mirrors in a region which is located at the top of the target surface 2 are assigned pixels of the pattern 5, which is formed on the projection surface 4, that are located far away from the edge 11, and that mirrors in a region which is located at the bottom of the target surface are assigned pixels of the pattern 5 that are located close to the edge 11.

For example, the target surface 2 in the exemplary embodiment of FIG. 8 has five regions 21-25, which are assigned five regions 53-57 of the pattern 5. Unlike in FIG. 7, the different brightnesses of the individual regions do not necessarily represent a different pixel brightness, but are merely intended to illustrate in principle the assignment of the individual regions. For example, mirrors in the region 21 of the target surface are assigned pixels of the region 53 of the pattern 5, mirrors in the region 22 of the target surface are assigned pixels of the region 54 of the pattern 5, mirrors in the region 23 of the target surface are assigned pixels of the region 55 of the pattern 5 etc.

Due to the described assignment of individual regions of target surface 2 and pattern 5, the image quality of the pattern 5 is improved, because distortions are reduced, and at the same time a situation is avoided of having to form on the target surface 2 mirrors 3 with a great inclination.

The idea of the exemplary embodiment of FIG. 7 that the pattern 5 has pixels onto which the light from a plurality of mirrors of the target surface 2 is reflected is also realized in FIG. 8, although this is not necessarily the case. For example, in FIG. 8, as explained, a specific assignment of regions of the target surfaces 2 to regions of the pattern 5 is performed, and in addition, different brightnesses are realized in accordance with FIG. 7. Provision is concretely made for in each case six mirrors of the region 21 of the target surface 2 to reflect onto a light pixel of the region 53. Two mirrors of the region 25 of the target surface 2 radiate onto a light pixel of the region 57.

Further provided in FIG. 8, although not necessary, is that the target surface has “blind mirrors,” i.e. mirrors at which the incident light is not reflected onto the pattern 5. For example in FIG. 8, near the edge 11, mirrors are provided which are aligned such that the reflected light travels substantially parallel or at a flat angle with respect to the projection surface 4, with the result that the observer cannot see the light therefrom, although it also creates no disturbance. These “blind mirrors” are not used to form the pattern 5, because they are arranged so far at the bottom, i.e. adjacent to the edge 11, that they are not suitable for projecting an image. Such “blind mirrors” can alternatively also be omitted entirely. For stability reasons with respect to the object 1 on the projection surface 4 and/or for production-technological reasons, it may however make sense to provide such “blind mirrors.”

FIG. 8 shows a further implementation of the invention. Provision is made in FIG. 8 for regions 28 to be integrated into the target surface 2 that form letters. Instead of letters, these regions 28 can also form numbers or other defined geometric shapes, such as company logos. In the regions 28, the mirrors have an identical or similar alignment, such that they form in the multiplicity of the mirrors letters which are recognizable by an observer.

However, the formation of regions 28 in which identically or similarly aligned mirrors are arranged such that they form defined shapes for the observer, such as letters, numbers or designs, requires a compromise in terms of the quality of the pixels of the design 5 which are produced using said mirrors. For example, the partial regions 28-1 and 28-2 of the region 28 have a different embodiment from the regions 23, 24 that surround them, i.e. mirrors of the partial region 28-1 are assigned pixels of the partial region 56 and mirrors of the partial region 28-2 are assigned pixels of the partial region 55, even if this means that the reflected light rays travel at a less favorable angle with respect to the target surface.

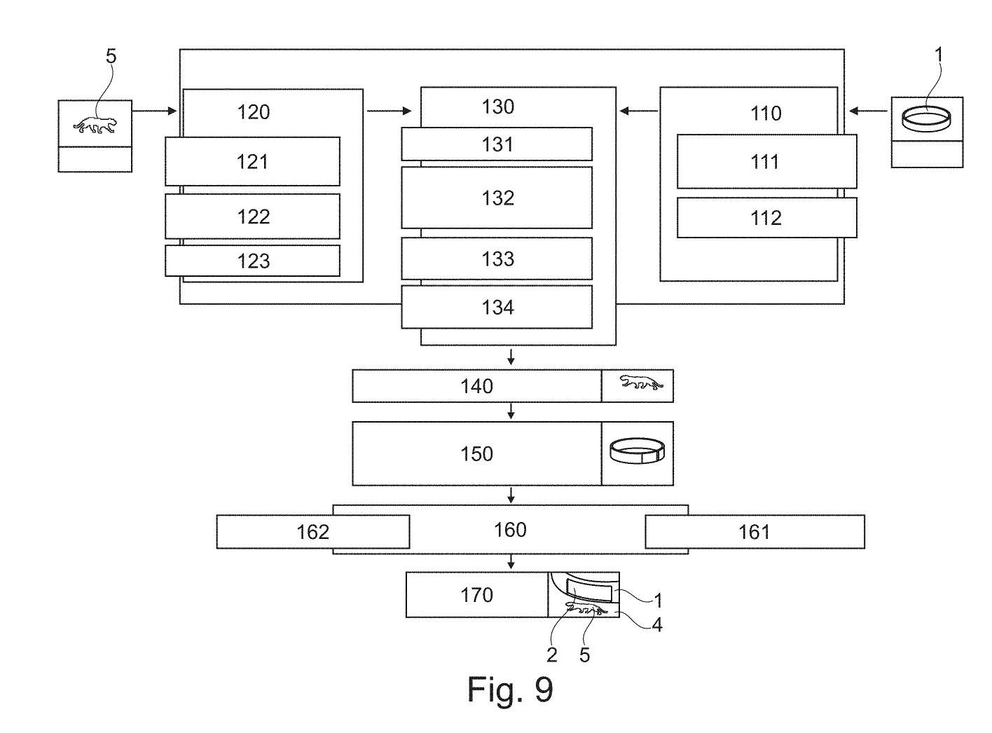

FIG. 9 shows a flowchart for producing a light-reflecting surface, which consists of a multiplicity of mirrors, on a three-dimensional object 1. Present as specified starting entities are the three-dimensional object 1 and the desired pattern 5. The pattern 5 is intended to be coded on a mirror surface of the object 1 by way of a multiplicity of mirrors, which are aligned in a defined fashion, in a manner such that, upon illumination of the mirrors with light from a specified direction, the pattern 5 is formed on a projection surface, for example the surface on which the object 1 is situated.

The object 1 is then used in an object analysis algorithm 110. The latter comprises an algorithm 111 for scanning the object surface. Here, position and size of the object surface are captured, and the surface is scanned with respect to depth variations. In the algorithm 112, the depth values are converted into a list of Z-values. In other words, the procedure is as follows. The 3D coordinates X, Y, Z are captured for each point in space of the object surface, on which mirrors are intended to be formed. The region of the object surface, on which mirrors are intended to be formed, here represents the target surface in accordance with the terminology as used up until now. The individual points in space, or regions which are assigned thereto, which are intended to later form in each case a mirror, are arranged in accordance with the mirrors to be formed in rows and columns. It is hereby possible to code the X-value and the Y-value of a point in space by way of the position that said point in space has in a list containing the points in space.

Accordingly, for each point in space only the Z value, which specifies a depth value (see the definition of the Z-axis in FIGS. 1 and 6) needs to be captured as a separate value.

The pattern 5 is then used in an image analysis algorithm 120. The algorithm 120 comprises a light intensification algorithm 121, in which it is possible to include, or which automatically provides suggestions as to, whether specific ones of the pixels of the image 50 are intended to have an increased brightness, in which case in accordance with FIG. 7 at least two mirrors must be assigned to such pixels. The algorithm 120 furthermore comprises a pixel array algorithm 122, by means of which the image 5 is converted into a multiplicity of pixels, which are arranged in an array having rows and columns. Each pixel is here assigned a brightness value, taking into consideration the light intensification algorithm 121. Hereby, in general pixels having a normal brightness are defined, wherein such pixels are assigned in each case one mirror, and pixels having an increased brightness are defined, wherein such pixels are assigned in each case at least 2 mirrors.

The algorithm 120 furthermore comprises an algorithm 123 for determining the number of mirrors. This algorithm calculates the required total number of mirrors that is required to realize the pixels which are prescribed by the light intensification algorithm 122, and the brightness thereof.

The results of the object analysis algorithm 110, i.e. the list, which has been established, of the object points at which mirrors can be formed, including the Z-values that are captured in this respect, and the results of the image analysis algorithm 120 with respect to the number and brightness values of the pixels, the position thereof in a desired, predefined projection surface, and with respect to the number of the required mirrors, are used in a trigonometric projection algorithm 130.

The algorithm 130 comprises an algorithm 131 for selecting the light source. It is possible here to prescribe whether the light source is parallel light or light from a point light source that is arranged at a defined point in space.

The algorithm 130 furthermore comprises an algorithm 132 for establishing the projection properties. To this end, the projection width and the projection height are input. Reference is made to FIG. 6 with respect to the definition of these terms. Since the individual mirrors at this location are not yet defined, provision may be made for a minimum projection width and a minimum projection height to be specified. If the pattern is intended to be located close to the mirror surface 2, the minimum projection width is selected to be small and the minimum projection height is selected to be great, wherein the reflected light rays, as explained with respect to FIG. 8, in accordance with an embodiment variant of the invention travel at an angle of between 30° to 60° with respect to the target surface (or, if the target surface has a strong curvature, at an angle of 30° to 60° with respect to a plane which is perpendicular to the projection surface).

The algorithm 130 furthermore comprises an algorithm 133 for introducing the light incidence angle. In the case of parallel light, the light incidence angle is specified. In the case of a point light source, the spatial coordinates of the point light source are input.

The algorithm 130 furthermore comprises an algorithm 134, which calculates the alignment of the individual mirror surfaces. The alignment of a mirror surface can be defined for example by the perpendicular vector, as explained with respect to FIG. 2. The algorithm 130 arranges the individual mirrors on the target surface of the light-reflecting object and aligns them here, wherein assignments in accordance with FIG. 8 can be performed. If the mirrors are rectangular, which is the case in accordance with an exemplary embodiment, the individual mirrors can here be defined by way of their corner points. Polynomials are drawn between the corner points, from which the mirror surfaces are produced.

This provides the required data for generating a mirror surface comprising a multiplicity of mirrors that are aligned in a defined manner. The data are passed in a file to a light simulation module 140. The latter performs light simulation by way of 3D animation software. This serves for checking whether the mirror surfaces provided generate the desired image 5 as a pattern.

If this check is positive, the data are passed on to a milling program, which performs conversion of the received data into a closed, three-dimensional object. Also calculated are milling paths for a milling head, a milling speed is set, and the milling head is selected. Highly precise milling of the mirrors is then performed in the module 160. To this end, for example a 5-axis milling machine is used. The milling technology or removal technology used can in principle be of any desired type. For example, mechanical milling, milling using laser, chemical etching or milling by way of water jets can be performed.

In order to provide high-quality planar mirror surfaces, a submodule 161 may be realized, which deburrs surfaces, which have been milled once, by way of repeated, identical milling, without removing additional material. The submodule 162 serves for selecting the desired reflective material, which is for example an aluminum alloy. Provision may be made here for reflective materials to be provided by way of or at material blocks, which are connected to one another at their rear sides and thereby form a curved plate. Such a curved plate is inserted into a cutout which is formed in the three-dimensional object. The milling operation subsequently takes place. Alternatively, the milling operation takes place before such a plate is arranged in the object.

After completion of the milling operation (step 170), a caustic object is provided, which has a multiplicity of reflective mirrors, which, upon illumination with light from a specified direction, image the desired pattern 5 onto a projection surface 4.

The invention in its implementation is not limited to the exemplary embodiments illustrated above, which are to be understood to be merely examples. For example, the shape and number of the mirror surfaces and the location and shape of the target surface and of the projection surface in the exemplary embodiments should be understood to be merely examples.

It should furthermore be noted that the features of the individual described exemplary embodiment of the invention can be combined with one another to form different combinations. Where ranges are defined, they comprise all the values within said ranges and any partial ranges that fall within a range.

1. A light-reflecting object having a multiplicity of individually aligned mirrors which are suitable for reflecting incident light such that the reflected light forms a predefined pattern on a projection surface, wherein:
the multiplicity of mirrors is formed or arranged on a curved target surface of the object,
each of the mirrors on the curved target surface of the object is aligned such that it images light, which is incident from a specified direction, onto exactly one pixel of the projection surface, and
the pattern formed on the projection surface is formed by the multiplicity of the pixels which are produced in this way.

2. The object as claimed in claim 1, wherein the mirrors are arranged and aligned such that, for at least one of the pixels, light that forms said pixel was reflected by exactly one of the mirrors.

3. The object as claimed in claim 1, wherein the mirrors are arranged and aligned such that, for at least one of the pixels, the light that forms said pixel was reflected by a plurality of the mirrors.

4. The object as claimed in claim 3, wherein such pixels of the projection surface are assigned a plurality of mirrors that have a greater distance from the curved target surface.

5. The object as claimed in claim 1, wherein the mirrors are arranged and aligned such, and the direction from which the light is incident on the mirrors is specified such, that, for at least some of the mirrors, the angle of a light ray, which has been reflected at an observed mirror, with respect to a plane that is perpendicular to the plane of the projection surface is between 30° and 60°, in particular between 40° and 50°.

6. The object as claimed in claim 1, wherein the mirrors are arranged and aligned such that some of the mirrors which are adjacent to one another have an identical or similar alignment such that they form in the multiplicity of the mirrors letters, numbers or designs which are recognizable for an observer.

7. The object as claimed in claim 1, wherein the mirrors are formed in one material block or in a plurality of material blocks, which consist of an aluminum alloy or include the same.

8. The object as claimed in claim 1, wherein the mirrors are embodied in material blocks that are connected to one another at their rear side and thereby form a curved plate, wherein the curved plate forms the curved target surface of the object and is inserted in a cutout formed in the object.

9. The object as claimed in claim 1, wherein the mirrors are embodied to be planar.

10. The object as claimed in claim 1, wherein the object is provided and embodied to form on the projection surface, by way of the multiplicity of individually aligned mirrors, a contiguous collection of pixels that form the predefined design. cm 11. A method for providing a light-reflecting object having a multiplicity of individually aligned mirrors, which are suitable for reflecting incident light such that the reflected light forms a predefined pattern on a projection surface, comprising:
arranging or forming a multiplicity of mirrors on a curved target surface of the object, wherein:
each of the mirrors on the curved target surface of the object is aligned such that it images light, which is incident from a specified direction, onto exactly one pixel of the projection surface, and
the pattern formed on the projection surface is formed by the multiplicity of the pixels which are produced in this way.

12. The method as claimed in claim 11, wherein each of the mirrors has a planar surface which is aligned such that its surface normal forms the bisector of the angle which is formed by the incident light ray and the light ray which is reflected onto one of the pixels, wherein for each mirror the planar surface is produced separately by way of a milling operation.

13. The method as claimed in claim 11, wherein the mirrors are arranged on the curved surface such that the light, which is reflected at an observed first mirror, cannot be blocked by a second mirror that is adjacent to the first mirror.

14. The method as claimed in claim 11, wherein the curved target surface of the object and the projection surface are substantially perpendicular with respect to one another.

15. The method as claimed in claim 11, wherein the mirrors are arranged and aligned such, and the direction from which the light is incident on the mirrors is specified such, that, for at least some of the mirrors, the angle of a light ray, which has been reflected at an observed mirror, with respect to a plane that is perpendicular to the plane of the projection surface is between 30° and 60°, in particular between 40° and 50°.

16. The method as claimed in claim 11, wherein the incident light, which is incident from a specified direction on the plurality of mirrors, which are arranged on the curved target surface, is parallel light.

17. The method as claimed in claim 11, wherein the incident light, which is incident from a specified direction on the plurality of mirrors, which are arranged on the curved target surface, is coming from a point light source.

18. The method as claimed in claim 11, wherein the mirrors are formed by one or more material blocks by way of milling, before the material block or the material blocks are arranged on the object.

19. The method as claimed in claim 18, wherein the mirrors are embodied in material blocks that are connected to one another at their rear side and thereby form a curved plate, wherein the curved plate forms the curved target surface of the object and is inserted in a cutout formed in the object.

20. The method as claimed in claim 11, wherein 3D data of the curved target surface of the object and data relating to the number, position and alignment of the mirrors are combined in a file which provides milling data for a milling machine.

21. The method as claimed in claim 20, wherein the X- and Y-data of the curved surface and/or the X- and Y-data of the position of the mirrors are coded in each case by the position in a list, such that the list only includes the corresponding Z-data.

22. The method as claimed in claim 11, wherein a planar surface is used as the projection surface.
